(19) United States
(12) Patent Application Publication
(10) Pub. No.: US 2007/0011270 A1
(43) Pub. Date: Jan. 11, 2007

(54) METHODS AND APPARATUS FOR INITIATING AND ALERTING A CONVERSATION WITH AN AUTOMATED AGENT

(76) Inventors: Stephen D. Klein, New York, NY (US); Gray Salmon Norton, Portola Valley, CA (US); James Pawlika, Glen Rock, NJ (US); Jennifer Villany, Woodbridge, NJ (US); Adam Erlebacher, New York, NY (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/424,113

(22) Filed: Jun. 14, 2006

Related U.S. Application Data
(60) Provisional application No. 60/690,241, filed on Jun. 14, 2005.

(51) Int. Cl. G06F 15/16

(52) U.S. Cl. 709/217

(57) ABSTRACT

Methods and apparatus for an automated agent to initiate a conversation with a user and alter the conversation based upon various parameters and/or user information.

### CROSS REFERENCE TO RELATED APPLICATIONS

The present application claims the benefit of U.S. Provisional Patent Application No. 60/690,241, filed on Jun. 14, 2005, which is incorporated herein by reference.

### BACKGROUND OF THE INVENTION

As is known in the art, automated agents can be accessible via a web site to initiate a textual conversation with a user. For example, a user can send queries to an automated agent to obtain support for a technical problem. Or a user can search various web pages to find a particular product or manufacturer. After clicking one of the web page links, the user can type in queries to which an automated agent can respond. However, such agents do not use the context in which the conversation was initiated.

### BRIEF DESCRIPTION OF THE DRAWINGS

The foregoing and other features of the present invention will be more readily apparent from the following detailed description and drawings of the illustrative embodiments of the invention in which:

FIG. 1 shows a high level block diagram of a first embodiment of a system implementing various aspects of the invention;

FIG. 2 is a block diagram of another embodiment of a system implementing various aspects of the present invention;

FIG. 3 is a block of a message routing system for use in the present invention;

FIG. 4 is a pictorial representation of conversation initiation in accordance with exemplary embodiments of the invention;

FIG. 5 is a diagram showing interaction between a browser application and an automated agent; FIG. 5 is a flow chart illustrating one technique of interpreting requests received from a user;

FIG. 6 is a pictorial representation of a sample link in the product sales area of a manufacturer web site;

FIG. 7 is a pictorial representation of a sample link in the product support area of a manufacturer's web site; and

FIG. 8 is a pictorial representation of a sample link in the specific product page of an e-commerce web site.

### DETAILED DESCRIPTION

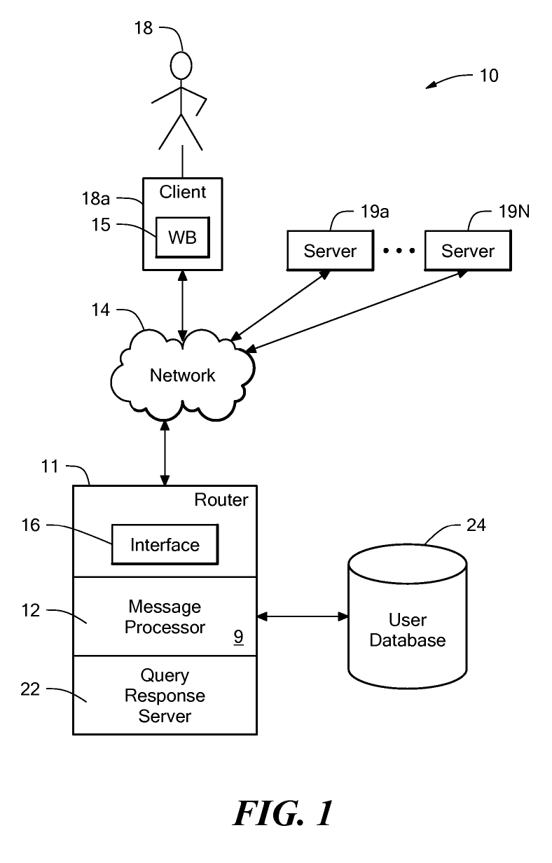

FIG. 1 shows a block diagram of a system 10 enabling users to initiate a conversation with an automated agent via a text chat interface by clicking on a web site link, for example, where the automated agent can alter the conversation based on the context of the user interaction. With this arrangement, a web user can selectively and efficiently obtain desired information via a conversation with the automated agent.

A user 18 can interact with a client workstation 18a having a web browser application 15 to view various web pages in a manner well known to one of ordinary skill in the art. Various servers 19a-N support web pages that can be accessed by the user via a network 14, e.g., the Internet.

In an exemplary embodiment, the system 10 further includes an interface 16 for a message router 11 connected to an automated agent 9 having a message processor 12 and a query response server 22. When the message processor 12 receives a request from the user 18, the request is forwarded to a local or remotely located query response server 22. In an exemplary embodiment, the query response server 22 includes a natural language interpreter or other intelligent system that is capable of responding to queries and other requests related to topics within at least a specified range of issues by generating an appropriate answer. The answer generated by query response server 22 is returned to the message processor 12 where it is incorporated into an output message that is subsequently sent to the user 18 through the network 14. Alternatively, or in addition to, the output message can be forwarded to the user through any other designated means, including E-mail, fax, text messaging to wireless or hand-held devices, voice mail (via a text to speech output system), or any other type of messaging system specified by the user.

Various types of information received during the query response interaction can be stored for later use in a user profile database 24 which contain various profiles associated with each user, such as by E-mail address. In one embodiment, the profile database 24 is preferably maintained on a separate server that is accessible to both the message processor 12 and the query response server 22, although other data storage configurations are feasible. By storing data provided by the user during a profile set up session and/or in response to data solicitation requests, a sophisticated query system can be provided which can make use of secondary or implied information to return a response which is more accurate or based on implicit data which need not be entered by the user in each query.

It will be appreciated that a large amount of default information can be provided in the user profile, such as a user age, or birth date, sex, place of residence, athletic teams of interest, product interest, restaurant preferences, stock portfolio information, etc. Because of the large quantity of information that can potentially be stored in the user profile, when a query from a user without a profile is detected, a “new user” procedure can be initiated in which the user is requested to provide various types of information to be stored in the user profile. In one embodiment, the user is directed to a specified profile web page in to which they can enter the various types of requested data. One particular method of directing the user to a web page is discussed in more detail below. In another embodiment, a user's profile is dynamically generated using information extracted from communications with the user, such as user-initiated queries.

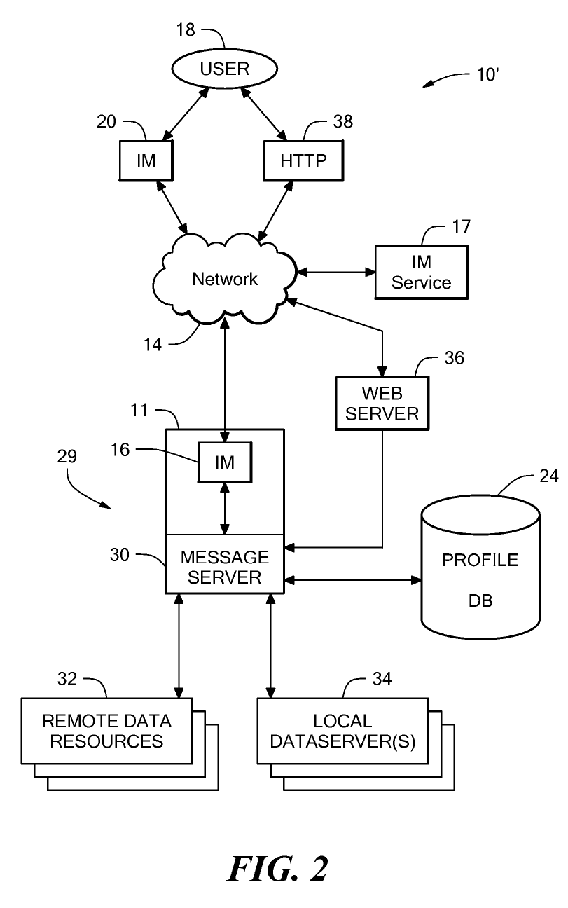

Turning to FIG. 2 there is shown another embodiment of a system 10′ for initiating and altering a conversation with an automated agent in accordance with exemplary embodiments of the invention. This system 10′ is generally similar to the embodiment of FIG. 1 in that a message router 29 is provided which includes a message server 30 for responding to user's requests and which is connected to an IM service 17 through a gateway 16. One difference is that the functionality of a separate query response server 22 of FIG. 1 is included within a local message server 30 such that query processing is not outsourced as a matter of course. Message server 30 is connected to the profile database 24 and also to a series of remote and local data resources 32, 34. In addition, server 30 can be configured to access the network 14 using multiple data protocols in addition to an IM protocol, and in particular, a hyper-text transfer protocol (“HTTP”) link via web server 36.

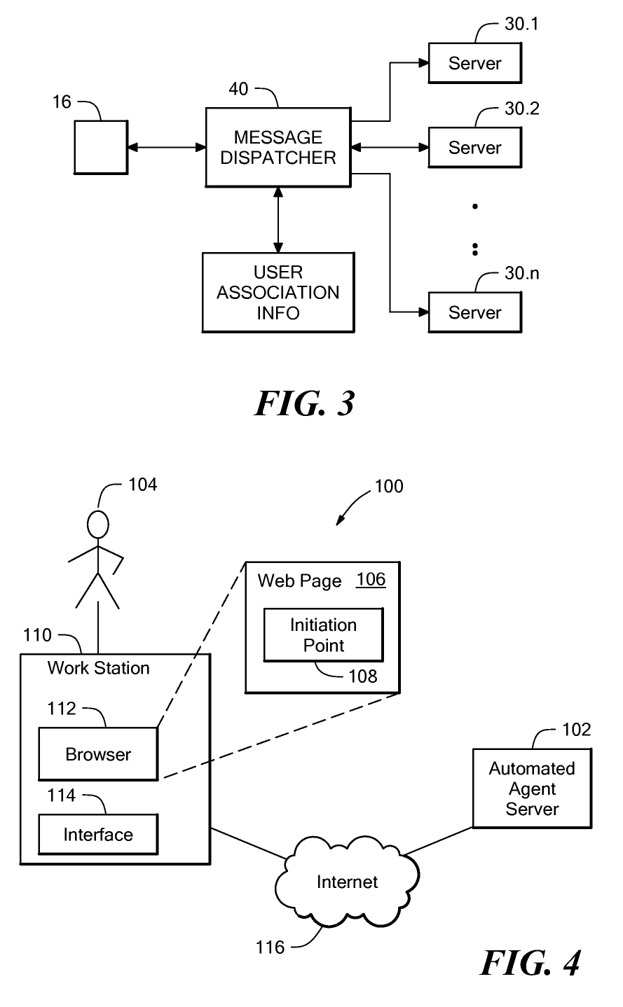

In operation, a large number of requests or queries can be pending for many users at the same time. Thus a larger number of separate “conversations” may be ongoing. In order to increase the system response time and decrease the load on any particular server, preferably the incoming and outgoing instant messaging data stream is handled by a message router and forwarded to a plurality of servers 30.1 through 30.N as illustrated in FIG. 3. In one embodiment, the message dispatcher 40 maintains a table 42 of active users associated with each server (a user-server association table). When a message is received from a user not currently in the user-server table 42, that user is assigned to a server and placed in the user-server table, e.g., on a lowest load basis such that the server with the lowest number of active users is assigned the new users. Then, as data packets are received from the user through the network interface 16, the data packets are processed by the message dispatcher 40 and routed to an appropriate server according to the user-server association table 42.

Advantageously, such a message dispatching system can be configured so that each server 30.x believes itself to be the only server in the system and is unaware of the intervening message router 40. In addition, the system can be configured so that the entire system or server 30.1 through 30.N appears to a user as a single server used by the system 10 (or 10′). This arrangement simplifies the addition of and removal of servers 30.x to the system without substantial reconfiguration being required. Various techniques for configuring a message router 40 will be known to those of skilled in the art. Preferably, the dispatcher 40 and user-server association table 42 are controlled with a suitable load balancing algorithm to evenly distribute the request load across the available server base in response to varying usage conditions.

In another aspect of the invention, a system allows users to initiate a conversation with an automated agent, also referred to as a conversational agent, from a click on a web site link, with the initial conversation subject and context altered based on the content of the link, the IP address of the user, the geo-location derived from the IP address, or other unique identifier that can be passed through a click on an URL. The initial and subsequent (during the course of the “conversation” with the user) behavior of the automated agent is adjusted to take into account the information passed to the agent via the click on the URL.

FIG. 4 shows an exemplary system 100 having a capability to initiate and alter a conversation between an automated agent 102 and a user 104 based upon user interaction with a web site page 106, such as a click on an initiation point 108, e.g., a web site link, in accordance with one embodiment of the present invention. The user 104 can control a workstation having a web browser application 112 and an interface 114 to communicate over a network 116. As will be readily understood by one of ordinary skill in the art, the browser application 112 enables the user 104 to display and interact with various web sites 106.

The system 100 enables the user 104 to initiate conversations with computer-based automated agents 102 which conversations are customized based upon the initiation point (e.g., link) 108 from which the conversation is initiated. In one embodiment, the user 104 is presented with one or more offers to click on a web page 106, or otherwise activate a conversation with the interactive agent via a chat interface 114. The offers to converse may be on unique web pages, or could reside on a single page with multiple topics offered.

In one embodiment, the web page 106 features multiple offers to converse with the automated agent 102, with topics varying based on which initiation point the user chooses. Each initiation point 108 is delivered to the automated agent application server at the initiation of the conversation with the user. While the invention is primarily shown and described as having the initiation point be provided as an URL, it is understood that the initiation point can be any suitable mechanism that points the user to an automated agent. In addition, it is understood that while the term “conversation” generally refers to typed textual interaction, conversation refers to any type of back and forth communication between the user and the automated agent, such as voice, symbols, sounds, visual, etc. The automated agent server 102 alters conversations based upon an initiating context constructed from the initiation point, as described more fully below.

In another embodiment, a web page features a single offer to engage the interactive agent, with the initiation point that is passed to the automated agent server specifically tailored to fulfill the automated content topic area that is most germane to the web page on which the initiation point resides.

With this arrangement, the dynamic of how the user 104 is served by the automated agent server 102 is enhanced by enabling the agent to initiate the conversation by exhibiting sensitivity to the user's specific purpose for engaging in the conversation. In one case, a user might engage an interactive agent from a support page of a product manufacturer's web site, in which case the interactive agent would begin the conversation by asking the user how they can support them with their product, perhaps presenting the user with some commonly asked support questions as examples to help them use the interactive agent. In another case, the interactive agent might be presented on a specific support area of a manufacturer's web site (e.g., battery replacement), in which case, rather than initiating the conversation with a general offer of support the interactive agent would engage the user in a conversation about the specific topic area (i.e. “here are the ways I can help you with your battery replacement process . . . ”), accelerating the conversation and usefulness of the interactive agent.

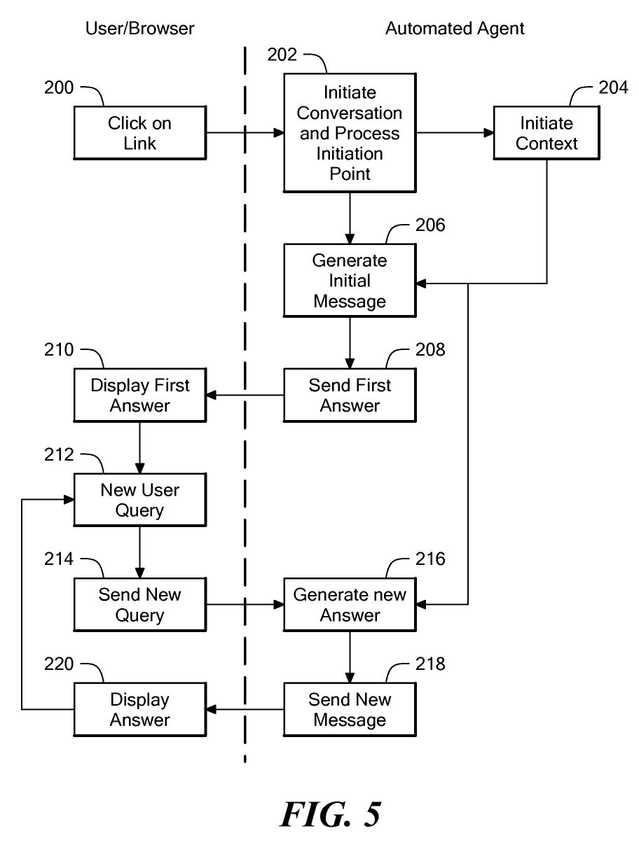

FIG. 5 is a diagram showing interaction between a web browser and an automated agent in an exemplary implementation of initiating and altering conversation in accordance with the present invention. In step 200, a user clicks on a web site link that is an initiation point URL. The initiation point is sent to the automated agent server, which then initiates a conversation with the user and processes the initiation point in step 202. In step 204, the context of the initiation is stored, as described more fully below. Some exemplary parameters that may be stored in the initiating context include the nature of the conversation, the site from which the conversation was initiated, a specific topic of inquiry, etc. It can also contain the initiating IP address. In one embodiment of the invention the initiation point is an URL. Using the context information as well optionally other information sources coming from a product database or a knowledge base, in step 206 the agent generates an initial message and sends the message to the user in step 208.

In an alternative embodiment of the invention, the initial question asked by the user to the interactive agent is the initiation point, and is evaluated for content and context and relevant parameters are parsed to form the initiating context. The initiation point can also be used as a parameter to set the subsequent conversation between the user and the interactive agent. For example, one user (User A) to an interactive agent might begin the conversation to interactive agent x with the query “how do I change the volume settings?” while another user (User B) might begin the conversation with the query “does it come with speakers?” The interactive agent application recognizes that User A is asking a support question about the product, and therefore the parameter indicating “support” will be set in the initiating context in step 204 based upon this initial user query, and the subsequent conversation with the interactive agent will result in step 208 taking a support posture and providing automated features that enhance the conversation with a user seeking product support.

The automated agent can recognize various topics using a variety of well known natural language and artificial processing techniques. A straightforward implementation uses a simple keyword driven detection ( detecting a sales interest when the keywords “buy” “purchase” or “interested” are used and detecting a support interest when keyword such as “problem”, “broken” . . . etc. are used). A more complex implementation can use a so-called natural language parser that can itself be implemented using a variety of well known techniques.

Via the same process, the automated agent recognizes that User B is asking a question that is related to product features in the context of evaluating the product for eventual purchase. In the case of User B, the interactive agent application recognizes that the initial query is pre-sales support information and based on this initial query the initiating context in step 204 will contain a parameter to be used to generate an initial message for subsequent conversation that establishes the tone of the conversation to be sales oriented, with tone and other automated elements that have the purpose of enticing User B to purchase the product.

In step 210, the web browser displays the answer. In step 212, the browser receives a new query from the user and, in step 214, sends the new query to the automated agent, which generates an answer in step 216. The answer is sent in step 218 to the browser for display in step 220.

In another embodiment of the invention, the initial question answered by the automated agent is actually defined by the initiation point. For example, a list of the most commonly questions is displayed to the user on a web page. Each of these questions is used as the initial question asked to the automated agent in a chat interface, for example.

In a further embodiment, the geographic location of the user is evaluated at the onset of the user session and a parameter is set in the initiating context in step 204 to use that location where appropriate in the subsequent conversation between the user and the automated agent. The geographic location is determined based on assessment of the IP (Internet Protocol) address of the user, or alternatively via a location-based service such as GPS, or alternatively other passive electronic means of capture and transmission of user location. Alternatively, or additionally as confirmation of geographic location information is passively acquired, the interactive agent may at the beginning of the conversation or at some point in the conversation where geographic information is initially required, ask the user for their location. During the course of the ensuing session with the user, the automated agent can access the location parameter established earlier in the session. As an example, a user sends a text message to an interactive agent from a mobile phone. The mobile carrier sends GPS location data as part of the message packet. The interactive agent sets a location parameter for that user session based on the location information passed to it. Subsequently in the conversation the user asks “where can I buy it?” and the interactive agent accesses a database of stores closest to the location parameter established at the onset of the conversation.

Some examples of how the content of the initiating context may be used in the ensuing conversation include offering tips and suggestions appended to responses to subsequent queries from the user that support the line of inquiry established by the parameter, configuring offerings and URLs presented in the ensuing conversation to be tailored to a specific target site. A further example of this use would be an automated agent programmed to respond to user inquiries about a specific manufacturer's product which is presented on the web sites of multiple electronic stores connected to the internet.

In one embodiment, when a user initiates a conversation with the automated agent from store A the URL underlying the presentation of the automated agent to the user of store A includes a parameter that informs the automated agent that the initiation of the conversation came from store A. If during the ensuing conversation between the user and the automated agent, the user asks where they can purchase the product, the automated agent uses the parameter in the initiating URL that informed the automated agent that the conversation was initiated from store A to present only information about purchasing the product from store A. When the same automated agent is presented to users of store B, the URL underlying the presentation of the automated agent to the user of store B includes a parameter that informs the automated agent that the initiation point of the conversation came from store B, therefore during the course of the users subsequent conversation with the automated agent, when the user asks the automated agent where they can purchase the product, the automated agent uses the parameter in the initiating URL that informed the automated agent that the conversation was initiated from store B to present only information about purchasing the product from store B.

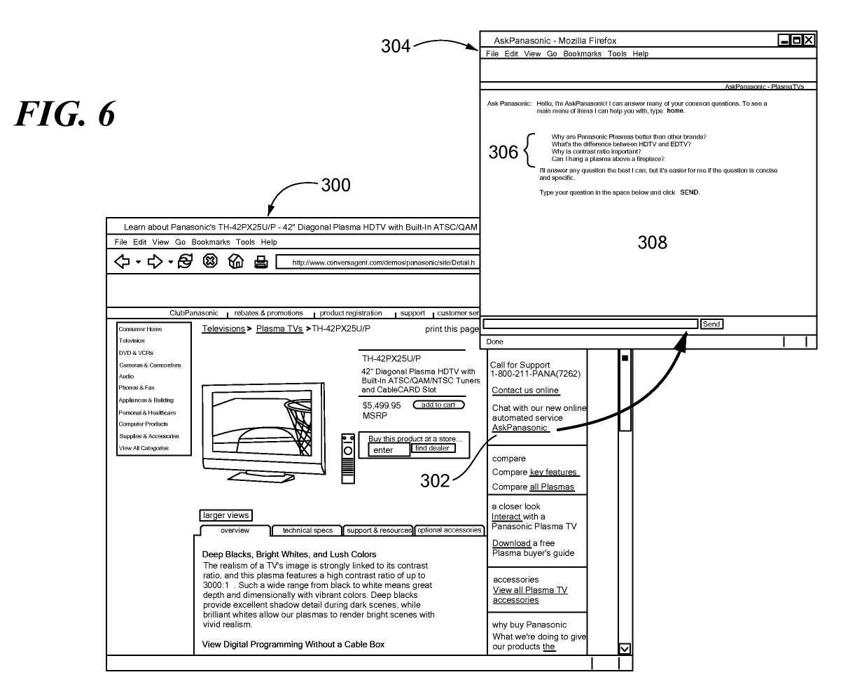

FIG. 6 is an exemplary pictorial representation of a link 302 in the product sales area of an illustrative manufacturer's web site 300. Upon clicking the link 302 in the sales area, the automated agent provides a screen display 304 to initiate a conversation with the user answering user queries to promoting a sale of the manufacture's products. For example, as shown the automated agent can provide example questions 306 directed to advantages of the manufacturer's products over other products and technical information regarding the product.

It is understood that web screens are intended to represent exemplary embodiments of the invention. The presented information is not intended to convey actual product information, company information, or any other type of information other than providing exemplary embodiments to describe the invention.

After the user clicks on the “AskPanasonic” link 302 a pop-up window 304 is generated for display by the user's browser application to initiate a conversation with an automated agent. The agent recognizes the user as having come from the purchasing area of manufacturer's site as part of the context and generates dialogue that skews the conversation towards selling product to the user. In the exemplary embodiment, the initiation point is an URL: http://askpanasonic.conversagent.com/?sales.

The exemplary window generated by the automated agent provides a series of questions 306 that can be answered by the agent, such as “Why are Panasonic Plasmas better than other brands?” Each of the illustrative questions can also be provided as links that provide the answer to the listed question(s). An area 308 is also provided for the user to type in questions to which the automated agent can respond and maintain a conversation.

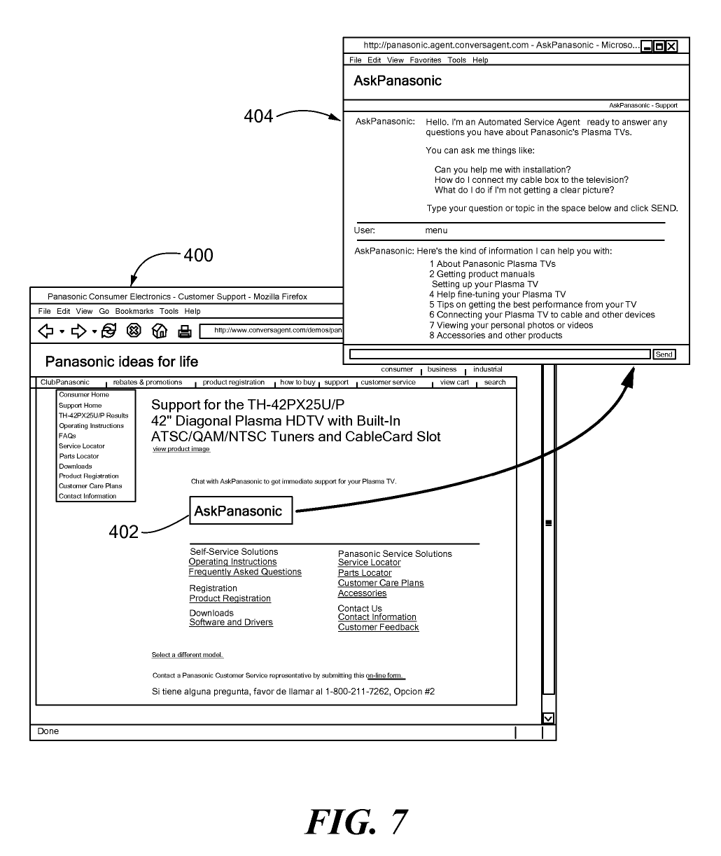

FIG. 7 is an exemplary pictorial representation of a sample link 402 in the product support area of an illustrative manufacturer's web site 400. After the user clicks on the link 402, a screen display 404 is generated that enables the user to initiate a conversation with the automated agent for responding to support-related user queries. As noted above, while the user perceives a support environment, the automated agent can respond to queries of other topics.

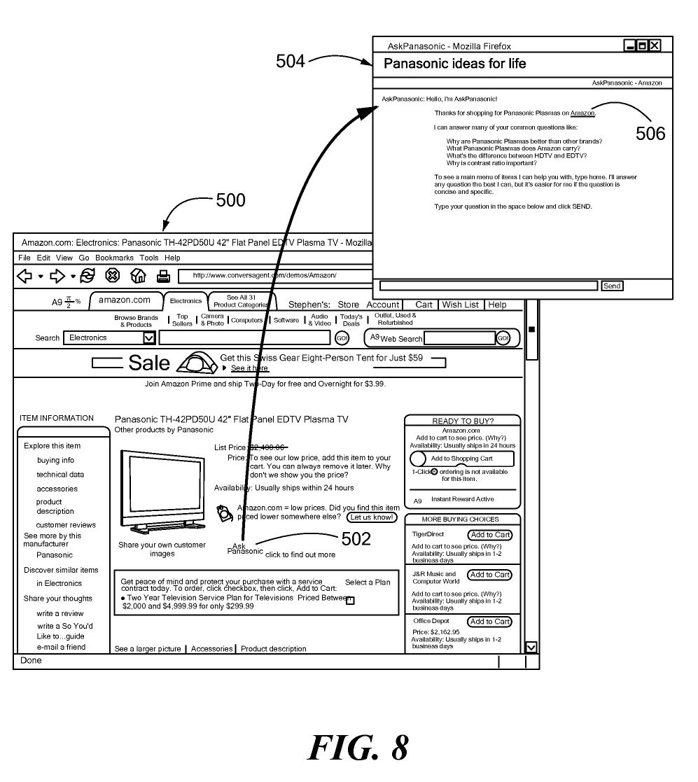

FIG. 8 is an exemplary pictorial representation of a sample link 502 in the specific product page of an exemplary e-commerce web site 500. By clicking on the link 502, a screen display 504 is generated through which the user can initiate a conversation with the automated agent. The display 504 can be similar to the display 404 of FIG. 3 having a sales-related context. The agent can indicate at a screen location 506 that the user clicked on a link from the particular e-commerce web site 500. With this arrangement, the e-commerce site 500 can monitor the products and vendors of most interest to consumers.

Various different programmable computer hardware platforms can be used to implement the several aspects of the present invention. In one embodiment, the various components, such as message routers, dispatcher, query response servers, etc., are implemented on one or more computer systems which are substantially identical at the hardware and operating system level. This simplifies interactivity between the various systems and makes it simpler to port functionality from one computer to another to distribute the workload in accordance with, e.g., the number of computer systems available. The computers should be connectable to each other, for example, by means of 100Base-T Ethernet interfaces and corresponding 100Base-T Ethernet switches. At least one of the computers is connected to the data network. As will be appreciated, the specific hardware utilized can be varied in accordance with need, required capacity, and the preferred programming and operating environment, as well as in response to other factors. Various architectures having differing partitions between hardware and software will be readily apparent to one of ordinary skill in the art.

It will be understood by those of skill in the art that various changes and additions to the methods and systems described above can be made without departing from the spirit and scope of the invention.

What is claimed is:

1. A method, comprising:
receiving a request from a user to initiate a conversation with an automated agent via interaction with an initiation point of a web site;
gathering a first set of information about the interaction with the initiation point of the web site;
obtaining a second set of information about the user;
initiating the conversation with the user;
altering, by the automated agent, the conversation with the user based upon the first and/or second set of information to provide responses to the user.

2. The method according to claim 1, wherein the user interaction with the initiation point of the web site includes receiving a click on a web site link.

3. The method according to claim 1, wherein the set of information gathered about the user interaction with the web site includes information identifying the originating link.

4. The method according to claim 1, wherein the second set of information includes an initial question by the user.

5. The method according to claim 1, wherein the second set of information includes a geographic location of the user.

6. The method according to claim 5, wherein the geographic location of the user is determined at least in part by an IP address associated with the user.

7. The method according to claim 1, further including using the web site information to tailor presented links to return to the web site.

8. The method according to claim 1, wherein the automated agent communicates via instant messaging.

9. A article, comprising:
a storage medium having stored thereon instructions that when executed by a machine result in the following:
receiving a request from a user to initiate a conversation with an automated agent via interaction with an initiation point of a web site;
gathering a first set of information about the interaction with the initiation point of the web site;
obtaining a second set of information for the user;
initiating the conversation with the user;
altering, by the automated agent, the conversation with the user based upon the first and/or second set of information to provide responses to the user.

10. The article according to claim 9, wherein the user interaction with the initiation point of the web site includes receiving a click on a web site link.

11. The article according to claim 9, wherein the set of information gathered about the user interaction with the web site includes information identifying the originating link.

12. The article according to claim 9, wherein the second set of information includes an initial question by the user.

13. The article according to claim 9, wherein the second set of information includes a geographic location of the user.

14. The article according to claim 13, wherein the geographic location of the user is determined at least in part by an IP address associated with the user.

15. The article according to claim 9, further including using the web site information to tailor presented links to return to the web site.

16. The method according to claim 9, wherein the automated agent communicates via instant messaging.

17. A system, comprising:
an automated agent for being coupled to a network to receive a request from a user to initiate a conversation with via interaction with an initiation point of a web site for gathering a first set of information about the interaction with the initiation point of the web site, obtain a second set of information for the user; initiating the conversation with the user, and alter the conversation with the user based upon the first and/or second set of information to provide responses to the user.

18. The system according to claim 17, wherein the user interaction with the initiation point of the web site includes receiving a click on a web site link.

19. The system according to claim 17, wherein the set of information gathered about the user interaction with the web site includes information identifying the originating link.

20. The system according to claim 17, wherein the second set of information includes an initial question by the user.

21. The system according to claim 17, wherein the second set of information includes a geographic location of the user.

22. The system according to claim 21, wherein the geographic location of the user is determined at least in part by an IP address associated with the user.

23. The system according to claim 17, further including using the web site information to tailor presented links to return to the web site.
